(19) United States
(12) Patent Application Publication
(10) Pub. No.: US 2014/0153281 A1
(43) Pub. Date: Jun. 5, 2014

(54) BACKLIGHT UNIT AND DISPLAY DEVICE

(71) Applicants: BEIJING BOE CHATANI ELECTRONICS CO., LTD., Beijing (CN); BOE TECHNOLOGY GROUP CO., LTD., Beijing (CN)

(72) Inventors: Yang ZHAO, Beijing (CN); Zhendong Zhou, Beijing (CN)

(21) Appl. No.: 14/097,202

(22) Filed: Dec. 4, 2013

(30) Foreign Application Priority Data
Dec. 4, 2012 (CN) 201210513239.X

(51) Int. Cl. F21V 8/00

(52) U.S. Cl. CPC G02B 6/0055; G02B 6/0051
USPC 362/607

(57) ABSTRACT

The present invention provides a backlight unit including a light source and a light guide plate, wherein the backlight unit further includes a set of reflectors, the set of reflectors includes a first reflector and a second reflector, the first reflector is arranged at a side of the light guide plate, the second reflector is arranged at the back of the light guide plate, the light source is arranged below the first reflector, the first reflector is used for reflecting light emitted from the light source into the light guide plate, and light exits from the front of the light guide plate after being scattered by the light guide plate and being reflected by the second reflector. Correspondingly, a display device including the backlight unit is provided. The backlight unit has advantages of small thickness, increased effective illumination area, and various shapes.

### FIELD OF THE INVENTION

The present invention relates to the field of display manufacturing technology, in particular, relates to a backlight unit, and a display device including the backlight unit.

### BACKGROUND OF THE INVENTION

Nowadays, a liquid crystal display (LCD) has been dominant in the panel display market for its advantages of small size, low power consumption, low radiation, and the like. In order to display an image on a screen of the LCD, it is necessary to configure a backlight unit (BLU) for a display panel. This is because the liquid crystals in the LCD can not emit light by themselves, and the liquid crystals just regulate the light.

In general, the BLUs may be categorized into side-edge backlight units and direct-type backlight units according to the distribution positions of light sources in the BLUs. The light source in the side-edge backlight unit is positioned at a side of the display panel, and the light source in the direct-type backlight unit is positioned at the back of the display panel.

As shown in FIG. 1, the existing direct-type backlight unit generally includes a backplane 1, a reflector 2 and a plurality of Light Emitting Diode (LED) strips 5 which are arranged on the backplane 1 (the LED strip 5 includes a strip-type PCB and a plurality of LEDs dispersedly arranged on the strip-type PCB), an optical film 4 arranged above the reflector 2, and an outer frame 6 which is arranged at the peripheries of the above components and used for fixing the above components together. The direct-type backlight unit have advantages of high optical efficiency, not requiring a light guide plate (as compared with the side-edge backlight unit), simple structure, and the like. However, the direct-type backlight unit requires a larger number of LEDs (Light Emitting Diodes). Since the LEDs are used as the light source, a certain light-mixing distance (i.e., the distance between the LED strip 5 and the optical film 4) is required when a higher degree of uniformity is desired. Thus, the direct-type backlight unit is generally thicker, and unable to be ultra-thin.

As shown in FIG. 2, the existing side-edge backlight unit generally includes a light guide plate (LGP) 3, LED strips 5 respectively arranged on the four sides around the LGP 3, a backplane 1 arranged at the back of the LGP 3, a reflector 2 arranged between the LGP 3 and the backplane 1, an optical film 4 arranged at the front of the LGP 3, and an outer frame 6 which is arranged at the peripheries of the above components and used for fixing the above components together. The side-edge backlight unit has advantage that the side-edge backlight unit is capable of being ultra-thin, because the LEDs acting as the light source emit light into the light guide plate from the sides of the light guide plate. However, since the light source is arranged at the sides of the light guide plate, a light-mixing distance (i.e., the distance between the LED strip 5 and a side of the light guide plate 3) in the horizontal direction is still required. Thus, the outer frame of the side-edge backlight unit is much larger than that of the direct type backlight unit, relatively reducing the effective illumination area thereof. Meanwhile, since the LED strips can only be formed in a linear and regular shape, it is difficult to form the side-edge backlight unit in a round shape or an irregular shape.

### SUMMARY OF THE INVENTION

In view of the above defects in the prior art, an object of the present invention is to provide a backlight unit which has advantages of small thickness, increased effective illumination area, and various shapes, and a display device including the backlight unit.

### Solutions to Solve the Problems

The present invention provides a backlight unit including a light source, a light guide plate, and a set of reflectors. The set of reflectors includes a first reflector and a second reflector. The first reflector is arranged at a side of the light guide plate, and the second reflector is arranged at the back of the light guide plate. The light source is arranged below the first reflector. The first reflector is used for reflecting light emitted from the light source into the light guide plate, and light exits from the front of the light guide plate after being scattered by the light guide plate and being reflected by the second reflector.

Preferably, a relationship between an angle between the first reflector and the bottom surface of the light guide plate and a light-emitting angle of the light source is

$$α \geq ( 90 + \frac{β}{2} ) \text{/} 2 ,$$

where α is the angle between the first reflector and the bottom surface of the light guide plate, and β is the light-emitting angle of the light source.

Preferably, the backlight unit further includes a backplane including a recessed portion and a platform portion, the light source is arranged into the recessed portion, and the light guide plate and the second reflector are arranged on the platform portion of the backplane.

Preferably, the light guide plate further includes a bulge which is arranged at the bottom edge of the light guide plate, the bulge extends into the recessed portion of the backplane, and the light source is arranged below the bulge.

Preferably, a relationship among a thickness of the bulge, a width of the bulge, and a light-emitting angle of the light source is

$$B \leq \frac{D}{2} sin ( 90 - \frac{β}{2} ) ,$$

where B is the thickness of the bulge, D is the width of the bulge, and β is the light-emitting angle of the light source.

Preferably, the first reflector and/or the second reflector extend(s) into the recessed portion of the backplane.

Preferably, an optical film is further arranged on the light guide plate, and the optical film includes a diffuser.

Preferably, a thickness of the backlight unit is less than 5 mm; and/or The backlight unit further includes an outer frame which is arranged at the peripheries of the light source, the light guide plate, the reflectors and the optical film to fix them together, and a width of the outer frame is less than 5 mm.

Preferably, the shape of the backplane is circular or polygonal, and the shape of the light guide plate is adaptive to that of the backplane; and/or The light source is a light emitting diode or an electroluminescent sheet.

The present invention also provides a display device including the backlight unit as described above.

### Advantageous Effects

The backlight unit according to the present invention can mix light uniformly in a short distance due to the fact that a direct-type side-light configuration (i.e., light emitted from the light source below the first reflector at a side of the light guide plate exits from the front of the light guide plate after being scattered by the light guide plate and being reflected by the second reflector at the back of the light guide plate) is employed. As compared with the existing direct-type backlight unit, the backlight unit according to the present invention can be ultra-thin (the thickness thereof is less than 5 mm); and the number of the LEDs (i.e., the light source) required is smaller. As compared with the existing side-edge backlight unit, the outer frame of the backlight unit according to the present is narrower (the width thereof is less than 5 mm), thereby increasing the effective illumination area relatively. The backlight unit according to the present invention can be circular, polygonal, or the like, having the advantage of diverse shapes, thereby expanding the application range of the backlight unit. The backlight unit also has advantages of good light-emitting effect, uniform emitted light, no stray light, etc.

### BRIEF DESCRIPTION OF THE DRAWINGS

FIG. 1 is a diagram illustrating the configuration of a direct-type backlight unit in the prior art;

FIG. 2 is a diagram illustrating the configuration of a side-edge backlight unit in the prior art;

FIG. 3 is a diagram illustrating the configuration of the backlight unit according to the embodiment 2 of the present invention; and

FIG. 4 is a diagram illustrating the configuration of the backlight unit according to the embodiment 3 of the present invention.

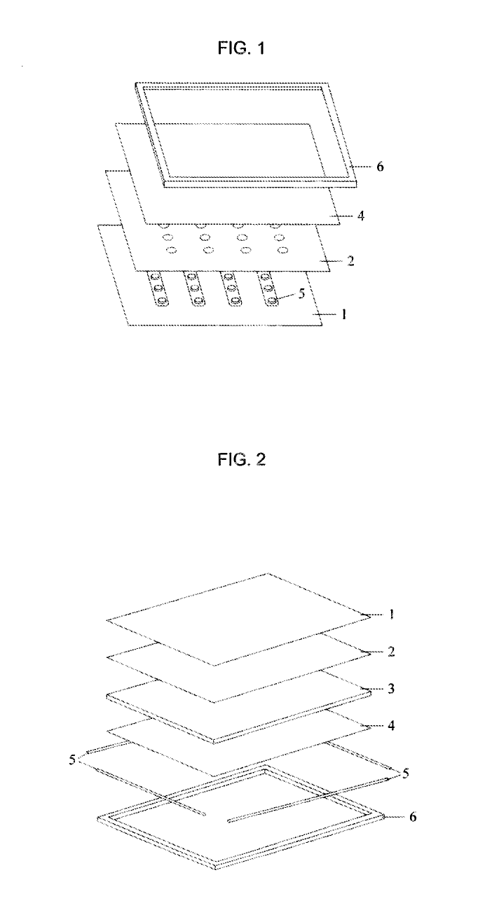

Wherein, 1—backplane; 2—reflector; 3—light guide plate; 3a—bulge; 4—optical film; 5—LED strip; 6—outer frame; 7—light source; 8—PCB; 9—first reflector; 10—second reflector.

### DETAILED DESCRIPTION OF THE EMBODIMENTS

For better understanding the solutions of the present invention by a person skilled in the art, a backlight unit and a display device including the backlight unit of the present invention will be described in detail with reference to the drawings and the following embodiments.

It should be understood that, orientation terms such as “front,” “back,” “side,” “bottom,” “on,” “below,” and the like used in the present invention are interpreted in a viewing angle in which the light emitted from a backlight unit enters into a user's eyes. If the viewing angle varies, these orientation terms may be changed accordingly.

### Embodiment 1

The present embodiment provides a backlight unit which includes a light guide plate, a light source, and a set of reflectors. The set of reflectors include a first reflector and a second reflector.

The first reflector is arranged at a side of the light guide plate. The second reflector is arranged at the back of the light guide plate. The light source is arranged below the first reflector. The first reflector is used to reflect light emitted from the light source into the light guide plate. Light is emitted from the front of the light guide plate after being scattered by the light guide plate and reflected by the second reflector.

The present embodiment further provides a display device including the backlight unit as described above.

It can be seen that light emitted from the light source in the backlight unit described in the present embodiment can uniformly mix in a short distance, since the light is emitted from the front of the light guide plate after being reflected by the first reflector and the second reflector respectively and after being scattered by the light guide plate.

### Embodiment 2

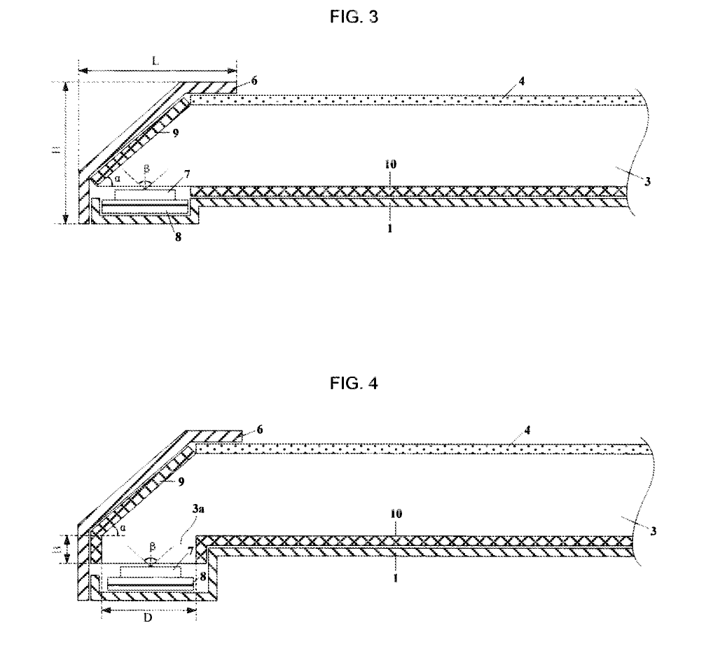

As shown in FIG. 3, the present embodiment provides a backlight unit, which includes a light guide plate 3, a light source 7, a PCB (printed circuit board) 8, an optical film 4, a first reflector 9, a second reflector 10, a backplane 1, and an outer frame 6. The optical film 4 includes a diffuser.

Wherein, the first reflector 9 is arranged at a side of the light guide plate 3, specifically may be arranged at any one or more of all sides of the light guide plate 3, and of course may be arranged at all sides around the light guide plate 3. The second reflector 10 is arranged at the back of the light guide plate 3. The light source 7 is arranged below the first reflector 9 and located on the PCB 8. It should be noted that, the light source 7 may be also arranged below the light guide plate 3, and the light-emitting surface of the light source 7 may be not in contact with the light guide plate 3 in order to prevent the light guide plate 3 being heated to melt due to heat generated by the light source 7 when operating. Preferably, a plurality of light sources may be used, and the plurality of light sources are separately arranged on the PCB 8 below the light guide plate 3. More preferably, structures and parameters of the respective light sources are the same, and distance between every two adjacent light sources is the same, i.e., all light sources are uniformly arranged on the PCB 8 at the same intervals. The optical film 4 is arranged at the front of the light guide plate 3. The backplane 1 includes a recessed portion and a platform portion. The light source 7 is arranged in the recessed portion of the backplane 1, and the light guide plate 3 and the second reflector 10 are arranged on the platform portion of the backplane 1. The outer frame 6 is arranged at the peripheries of the above components and used for fixing the above components together.

The light guide plate 3 is provided with light guide mesh points of different sizes at different intervals on the bottom thereof. The light guide mesh points may be of a strip shape, a triangle shape, a dot shape, an ellipsoidal shape, or the like. Light incident on the bottom of the light guide plate 3 will form a uniform surface light source after being scattered by the light guide mesh points on the bottom of the light guide plate 3.

Light emitted from the light source 7 is reflected by the first reflector 9 at the side of the light guide plate 3, then transmits inward from the side of the light guide plate 3 to the second reflector 10 at the bottom of the light guide plate 3, and is reflected by the second reflector 10 and scattered by the light guide plate 3, finally exits from the optical film 4 at the front of the light guide plate 3 (towards the display panel).

The top of the outer frame 6 extends onto a top edge of the optical film 4, and the bottom or a bottom side of the outer frame 6 is connected to the backplane 1 by a fastening member (e.g., a bolt, stud or screw) or by a snap and a slot (the snap and the slot fit each other).

Preferably, a light emitting diode (LED) or an electroluminescent sheet may be used as the light source 7.

In order to increase the utilization ratio of the reflected light of light emitted from the light sources 7 after being reflected by the first reflector 9, the first reflector 9 may be arranged obliquely to increase the brightness of the backlight unit, meanwhile the side of the light guide plate 3 is arranged obliquely. Preferably, a relationship between an angle α (the angle α is an angle between the first reflector 9 and the bottom surface of the light guide plate 3, i.e., an angle between a side surface of the light guide plate 3 and the bottom surface of the light guide plate 3) and a light-emitting angle β of the light source 7 is

$$α \geq ( 90 + \frac{β}{2} ) \text{/} 2. \qquad ( 1 )$$

When a LED is used as the light source 7, since the light-emitting angle of the LED is generally 120 degrees, then β=120° and α≧75°.

Preferably, a thickness H of the backlight unit is less than 5 mm, and a width L of the outer frame 6 is less than 5 mm. It can be seen that, since light emitted from the light source 7 is reflected by the first reflector 9 and the second reflector 10, the light is sufficiently mixed in the light guide plate 3. Thus, as compared with the existing direct-type backlight unit, a distance between the light-emitting surface of the light source 7 and the optical film 4 is shorter, enabling the overall thickness of the backlight unit according to the present invention to be thinner. As compared with the existing side-edge backlight unit, a light-mixing distance in the horizontal direction is not required, enabling the thickness of the outer frame of the backlight unit according to the present invention to be narrower. Furthermore, experimental analysis shows that, of the backlight unit according to the present invention, light-emitting effect is good, the emitted light is uniform, and stray light does not exist.

Preferably, the shape of the backplane 1 is circular or polygonal, and the shape of the light guide plate 3 is adaptive to that of the backplane 1. Thus, the shape of the backlight unit may be circular or polygonal, thereby expanding the application range of the backlight unit.

The present embodiment further provides a display device, which includes a display panel and the backlight unit as described above. The optical film 4 is arranged between the display panel and the light guide plate 3. The optical film 4 is not in contact with the display panel because the optical film 4 and the display panel are spaced apart from each other by the portion of the outer frame 6 which extends onto the top edge of the optical film 4, so that adsorption between the optical film 4 and the display panel is prevented, wherein the adsorption can affect display effect.

Other configurations of the backlight unit of the present embodiment and functions thereof are the same as those of Embodiment 1, and description thereof is omitted.

### Embodiment 3

As shown in FIG. 4, the backlight unit according to the present embodiment is different from that according to Embodiment 2 in that:

The light guide plate 3 of the backlight unit further includes a bulge 3a which is arranged at a bottom edge of the light guide plate 3. The bulge 3a extends into a recessed portion of the backplane 1. The light source 7 is arranged below the bulge 3a (the light-emitting surface of the light source 7 is not in contact with the bulge 3a either), to avoid light emitted from a portion of the light source 7 which is close to the first reflector 9 being unable to be transmitted to the optical film 4 and being lost, due to limitation of the light-emitting angle of the light source. Thus, the utilization ratio of the reflected light of light emitted from the light source after being reflected by the first reflector 9 is increased.

Preferably, the relationship among the thickness B of the bulge 3a, the width D of the bulge 3a, and the light-emitting angle β of the light source is

$$B \leq \frac{D}{2} sin ( 90 - \frac{β}{2} ) . \qquad ( 2 )$$

Preferably, the first reflector 9 and/or the second reflector 10 extend(s) into the recessed portion of the backplane 1.

The present embodiment also provides a display device including the backlight unit as described above.

Other configurations of the backlight unit according to the present embodiment and functions thereof are the same as those of Embodiment 2, and description thereof is omitted.

It should be understood that, the above embodiments are only exemplary embodiments for the purpose of explaining the principle of the present invention, and the present invention is not limited thereto. For a person skilled in the art, various improvements and modifications may be applied to the present invention without departing from the spirit and essence of the present invention. These improvements and modifications are also covered by the scope of the claims of the present invention.

1. A backlight unit including a light source and a light guide plate, wherein the backlight unit further includes a set of reflectors, the set of reflectors includes a first reflector and a second reflector, the first reflector is arranged at a side of the light guide plate, the second reflector is arranged at the back of the light guide plate, the light source is arranged below the first reflector, the first reflector is used for reflecting light emitted from the light source into the light guide plate, and light exits from the front of the light guide plate after being scattered by the light guide plate and being reflected by the second reflector.

2. The backlight unit according to claim 1, wherein a relationship between an angle between the first reflector and the bottom surface of the light guide plate and a light-emitting angle of the light source is
$$α \geq ( 90 + \frac{β}{2} ) \text{/} 2 ,$$
wherein α is the angle between the first reflector and the bottom surface of the light guide plate, and β is the light-emitting angle of the light source.

3. The backlight unit according to claim 1, wherein the backlight unit further includes a backplane including a recessed portion and a platform portion, the light source is arranged into the recessed portion, and the light guide plate and the second reflector are arranged on the platform portion of the backplane.

4. The backlight unit according to claim 3, wherein the light guide plate further includes a bulge which is arranged at the bottom edge of the light guide plate, the bulge extends into the recessed portion of the backplane, and the light source is arranged below the bulge.

5. The backlight unit according to claim 4, wherein a relationship among a thickness of the bulge, a width of the bulge, and a light-emitting angle of the light source is
$$B \leq \frac{D}{2} sin ( 90 - \frac{β}{2} ) ,$$
wherein B is the thickness of the bulge, D is the width of the bulge, and β is the light-emitting angle of the light source.

6. The backlight unit according to claim 4, wherein the first reflector and/or the second reflector extend(s) into the recessed portion of the backplane.

7. The backlight unit according to claim 5, wherein the first reflector and/or the second reflector extend(s) into the recessed portion of the backplane.

8. The backlight unit according to claim 1, wherein an optical film is further arranged on the light guide plate, and the optical film includes a diffuser.

9. The backlight unit according to claim 8, wherein
a thickness of the backlight unit is less than 5 mm; and/or
the backlight unit further includes an outer frame which is arranged at the peripheries of the light source, the light guide plate, the reflectors and the optical film to fix them together, a width of the outer frame is less than 5 mm.

10. The backlight unit according to claim 1, wherein
the shape of the backplane is circular or polygonal, and the shape of the light guide plate is adaptive to that of the backplane; and/or
the light source is a light emitting diode or an electroluminescent sheet.

11. The backlight unit according to claim 2, wherein
the shape of the backplane is circular or polygonal, and the shape of the light guide plate is adaptive to that of the backplane; and/or
the light source is a light emitting diode or an electroluminescent sheet.

12. The backlight unit according to claim 3, wherein
the shape of the backplane is circular or polygonal, and the shape of the light guide plate is adaptive to that of the backplane; and/or
the light source is a light emitting diode or an electroluminescent sheet.

13. The backlight unit according to claim 4, wherein
the shape of the backplane is circular or polygonal, and the shape of the light guide plate is adaptive to that of the backplane; and/or
the light source is a light emitting diode or an electroluminescent sheet.

14. The backlight unit according to claim 5, wherein
the shape of the backplane is circular or polygonal, and the shape of the light guide plate is adaptive to that of the backplane; and/or
the light source is a light emitting diode or an electroluminescent sheet.

15. The backlight unit according to claim 6, wherein
the shape of the backplane is circular or polygonal, and the shape of the light guide plate is adaptive to that of the backplane; and/or
the light source is a light emitting diode or an electroluminescent sheet.

16. The backlight unit according to claim 7, wherein
the shape of the backplane is circular or polygonal, and the shape of the light guide plate is adaptive to that of the backplane; and/or
the light source is a light emitting diode or an electroluminescent sheet.

17. The backlight unit according to claim 8, wherein
the shape of the backplane is circular or polygonal, and the shape of the light guide plate is adaptive to that of the backplane; and/or
the light source is a light emitting diode or an electroluminescent sheet.

18. A display device including a backlight unit, wherein
the backlight unit includes a light source and a light guide plate, wherein the backlight unit further includes a set of reflectors, the set of reflectors includes a first reflector and a second reflector, the first reflector is arranged at a side of the light guide plate, the second reflector is arranged at the back of the light guide plate, the light source is arranged below the first reflector, the first reflector is used for reflecting light emitted from the light source into the light guide plate, and light exits from the front of the light guide plate after being scattered by the light guide plate and being reflected by the second reflector.

19. The display device according to claim 18, wherein a relationship between an angle between the first reflector and the bottom surface of the light guide plate and a light-emitting angle of the light source is
$$α \geq ( 90 + \frac{β}{2} ) \text{/} 2 ,$$
where α is the angle between the first reflector and the bottom surface of the light guide plate, and β is the light-emitting angle of the light source.

20. The display device according to claim 18, wherein the backlight unit further includes a backplane including a recessed portion and a platform portion, the light source is arranged into the recessed portion, and the light guide plate and the second reflector are arranged on the platform portion of the backplane.
